(19) United States
(12) Patent Application Publication
(10) Pub. No.: US 2005/0181825 A1
(43) Pub. Date: Aug. 18, 2005

(54) Wireless peripheral voice input device

(76) Inventor: Yaz-Tzung Wu, Taipei (TW)

Correspondence Address: FULBRIGHT AND JAWORSKI L L P;PATENT DOCKETING 29TH FLOOR, 865 SOUTH FIGUEROA STREET, LOS ANGELES, CA, 900172576, US

(21) Appl. No.: 10/779,377

(22) Filed: Feb. 13, 2004

(51) Int. Cl. H04M 1/00

(52) U.S. Cl. 455/556.1

(57) ABSTRACT

A wireless peripheral voice input device is proposed, which is designed for use with a computer platform, such as a desktop computer, a notebook computer, a tablet computer, and the like, for the user to input voice to the computer platform by way of a wireless peripheral device, such as a wireless multimedia controller or a wireless mouse device. The proposed wireless peripheral voice input device is advantageous to use in that it allows users to use it for voice input to the computer platform at a remote distance from the computer platform, without having to crowd beside the computer platform. Moreover, since the proposed wireless peripheral voice input device is integrated to a standard wireless multimedia controller or a wireless mouse device, it allows the user to add a wireless voice input capability to his/her computer platform without having to additionally purchase a wireless microphone unit.

### BACKGROUND OF THE INVENTION

1. Field of the Invention

This invention relates to computer peripheral technology, and more particularly, to a wireless peripheral voice input device which is designed for use with a computer platform, such as a desktop computer, a notebook computer, a tablet computer, and so on, for the user to input voice to the computer platform by way of a standard wireless peripheral device, such as a wireless multimedia controller, a wireless mouse device, and so on.

2. Description of Related Art

A computer-based karaoke system is a computerized multimedia system that is installed on a computer platform, such as a desktop computer, a notebook computer, a tablet computer, and so on, and is capable of outputting audio (i.e., music) from the audio output module on the computer platform as well as video (such as a filmed video program) and text (words of a song) from the monitor screen of the computer platform so that the user can sing against a microphone along with the music video. The user's singing voice is then amplified and mixed with the music video and broadcast from the audio output module on the computer platform.

One drawback to the conventional computer-based karaoke system, however, is that the microphone unit is typically built in the body of desktop computer or notebook computer, such that when a group of users want to use the microphone to sing together with the music video, they have to crowd beside the desktop computer or notebook computer, which is undoubtedly quite inconvenient to use.

### SUMMARY OF THE INVENTION

It is therefore an objective of this invention to provide a wireless peripheral voice input device which allows a user or a group of users to input voice to the computer platform at a remote distance from the computer platform so as to allow users of computer-based karaoke systems to conveniently use the wireless peripheral voice input device for voice input to the computer platform.

It is another objective of this invention to provide a wireless peripheral voice input device which allows the user to add a wireless voice input capability to his/her computer platform without having to additionally purchase a wireless microphone unit.

The wireless peripheral voice input device according to the invention is designed for use with a computer platform, such as a desktop computer, a notebook computer, a tablet computer, and the like, for the user to input voice to the computer platform by way of a standard wireless peripheral device for the computer platform, such as a wireless multimedia controller, a wireless mouse device, and so on.

The wireless peripheral voice input device according to the invention comprises: (a) a sound pickup module, which is integrated to the wireless peripheral device, and which is capable of picking up natural sound from the surrounding environment; (b) a sound transducing module, which is integrated to the wireless peripheral device, and which is capable of transforming the natural sound picked by the sound pickup module into an electrical audio signal; (c) an audio signal modulation module, which is integrated to the wireless peripheral device, and which is capable of modulating the electrical audio signal from the sound transducing module into a modulated audio signal; (d) a transmitting wireless interface module, which is integrated to the wireless peripheral device, and which is capable of converting the modulated audio signal from the audio signal modulation module into a wireless audio signal and emitting the wireless audio signal into the surrounding environment; and (e) a reception wireless interface module, which is coupled to the computer platform, and which is capable of receiving the wireless audio signal from the transmitting wireless interface module on the wireless peripheral device and transferring the received audio signal to the computer platform.

The wireless peripheral voice input device according to the invention is more advantageous to use than prior art in that it allows a user or a group of users to use it for voice input to the computer platform at a remote distance from the computer platform, without having to crowd beside the computer platform as in the case of prior art. Moreover, since the wireless peripheral voice input device of the invention is integrated to a standard wireless multimedia controller or a wireless mouse device, it allows the user to add a wireless voice input capability to his/her computer platform without having to additionally purchase a wireless microphone unit.

### BRIEF DESCRIPTION OF DRAWINGS

The invention can be more fully understood by reading the following detailed description of the preferred embodiments, with reference made to the accompanying drawings, wherein:

FIG. 1 is a schematic diagram showing an object-oriented component model of the wireless peripheral voice input device according to the invention;

FIG. 2A is a schematic diagram showing a first preferred embodiment where the wireless peripheral voice input device according to the invention is integrated to a wireless multimedia controller; and

FIG. 2B is a schematic diagram showing a second preferred embodiment where the wireless peripheral voice input device according to the invention is integrated to a wireless mouse device.

### DETAILED DESCRIPTION OF PREFERRED EMBODIMENTS

The wireless peripheral voice input device according to the invention the invention is disclosed in full details by way of preferred embodiments in the following with reference to the accompanying drawings.

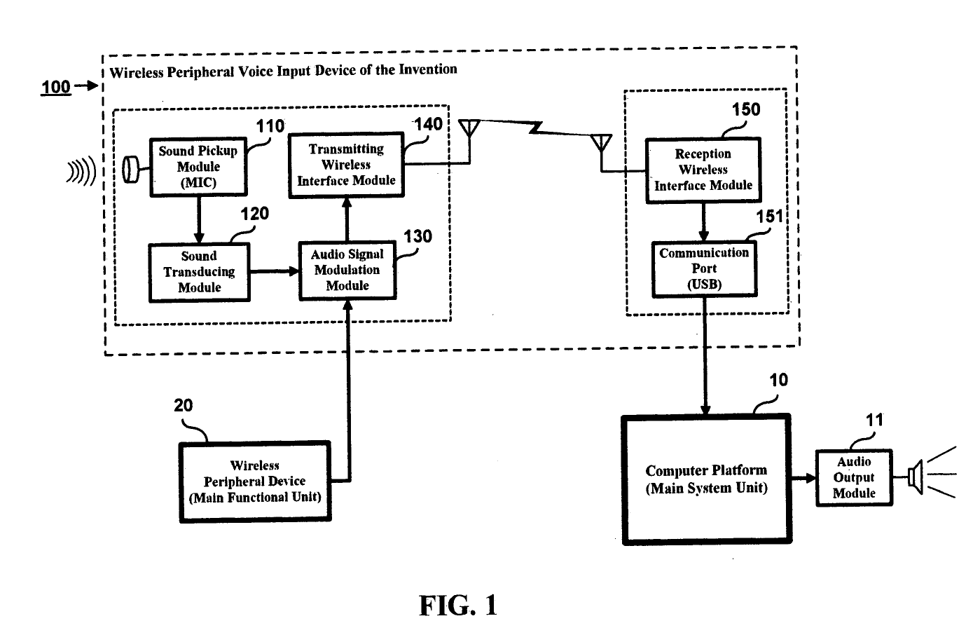

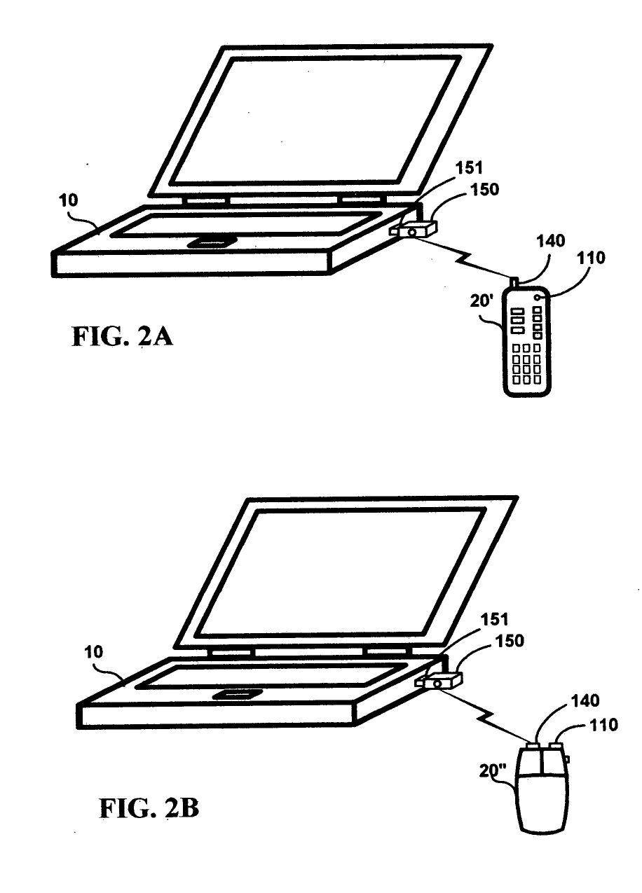

FIG. 1 is a schematic diagram showing an object-oriented component model of the wireless peripheral voice input device according to the invention (as the part enclosed in the dotted box indicated by the reference numeral 100). As shown, the wireless peripheral voice input device of the invention 100 is designed for use in conjunction with a computer platform 10, such as a notebook computer, a desktop computer, a tablet computer, and so on, for the purpose of allowing a user-operated voice input to the computer platform 10 by way of a standard wireless peripheral device 20, such as a wireless multimedia controller 20′ shown in FIG. 2A or a wireless mouse device 20″ shown in FIG. 2B.

In practical use, for example, the wireless peripheral voice input device of the invention 100 can be used with a computer-based karaoke system installed on the computer platform 10, so that the user can normally use the wireless multimedia controller 20′ to operate a multimedia system, such as Microsoft Media Center, or use the wireless mouse device 20″ for working with the operating system and various applications on the computer platform 10; and when it is needed to use the karaoke system, the user can then use either the wireless multimedia controller 20′ or the wireless mouse device 20″ as a wireless microphone unit for user-operated voice input to the computer platform 10 to allow the user's singing voice to be amplified and broadcast to the surrounding environment via an audio output module 11 installed on the computer platform 10.

As shown in FIG. 1, the object-oriented component model of the wireless peripheral voice input device of the invention 100 comprises the following modules: (a) a sound pickup module 110; (b) a sound transducing module 120; (c) an audio signal modulation module 130; (d) a transmitting wireless interface module 140; and (e) a reception wireless interface module 150.

The sound pickup module 110 is a microphone unit, which is integrated to the wireless peripheral device 20, and which is capable of picking up natural sound from the surrounding environment, such as the user's speech or singing voice.

The sound transducing module 120 is also integrated to the wireless peripheral device 20, and which is capable of transforming the natural sound picked by the sound pickup module 110 into an electrical audio signal.

The audio signal modulation module 130 is also integrated to the wireless peripheral device 20, and which is capable of modulating the electrical audio signal from the sound transducing module 120 into a modulated audio signal. Since the modulation method utilized by the audio signal modulation module 130 is conventional technology, detailed description of the internal architecture of the audio signal modulation module 130 will not be given in this specification.

The transmitting wireless interface module 140 is also integrated to the wireless peripheral device 20, and which is capable of converting the modulated audio signal from the audio signal modulation module into a wireless audio signal and then emitting the wireless audio signal into the surrounding environment. Since the radio transmitting method utilized by the transmitting wireless interface module 140 is conventional technology, detailed description of the internal architecture of the transmitting wireless interface module 140 will not be given in this specification.

The reception wireless interface module 150 is, for example, an external unit that can be coupled via a communication port, such as a standard USB (Universal Serial Bus) port, to the computer platform 10, and which is capable of receiving the wireless audio signal from the transmitting wireless interface module 140 on the wireless peripheral device 20 and transferring the received audio signal to the computer platform 10 where the audio signal can be amplified and converted by an audio output module 11 into natural sound and broadcast to the surrounding environment.

In practical use, the user can normally use the wireless multimedia controller 20′ to operate a multimedia system, such as Microsoft Media Center, that is installed on the wireless peripheral device 20, or use the wireless mouse device 20″ to work with the operating system and applications installed on the computer platform 10.

When it is needed to use the karaoke system, the user can then use either the wireless multimedia controller 20′ shown in FIG. 2A or the wireless mouse device 20″ shown in FIG. 2B as a wireless microphone and utter sounds against the sound pickup module 110 on the wireless peripheral device 20. This causes the sound pickup module 110 to pick up the user's natural sound and the sound transducing module 120 to transform the natural sound picked by the sound pickup module 110 into an electrical audio signal. Subsequently, the audio signal modulation module 130 modulates the electrical audio signal from the sound transducing module 120 into a modulated audio signal and transfers the modulated audio signal to the transmitting wireless interface module 140 where the modulated audio signal from the audio signal modulation module 130 is converted into a wireless audio signal and emitted into the surrounding environment. The emitted wireless audio signal is then received by the reception wireless interface module 150 on the computer platform 10 and transferred via the USB port 151 to the computer platform 10 where the audio signal can be amplified and converted by an audio output module 11 into natural sound and broadcast to the surrounding environment.

In conclusion, the invention provides a wireless peripheral voice input device, which is designed for use with a computer platform, such as a desktop computer, a notebook computer, a tablet computer, and the like, for the user to input voice to the computer platform by way of a standard wireless peripheral device, such as a wireless multimedia controller, a wireless mouse device, and so on. The wireless peripheral voice input device according to the invention is more advantageous to use than prior art in that it allows a user or a group of users to use it for voice input to the computer platform at a remote distance from the computer platform, without having to crowd beside the computer platform as in the case of prior art. Moreover, since the wireless peripheral voice input device of the invention is integrated to a standard wireless multimedia controller or a wireless mouse device, it allows the user to add a wireless voice input capability to his/her computer platform without having to additionally purchase a wireless microphone unit. The invention is therefore more advantageous to use than the prior art.

The invention has been described using exemplary preferred embodiments. However, it is to be understood that the scope of the invention is not limited to the disclosed embodiments. On the contrary, it is intended to cover various modifications and similar arrangements. The scope of the claims, therefore, should be accorded the broadest interpretation so as to encompass all such modifications and similar arrangements.

1. A wireless peripheral voice input device for use in conjunction with a computer platform for user-operated voice input to the computer platform by way of a wireless peripheral device;
the wireless peripheral voice input device comprising:
a sound pickup module, which is integrated to the wireless peripheral device, and which is capable of picking up natural sound from the surrounding environment;
a sound transducing module, which is integrated to the wireless peripheral device, and which is capable of transforming the natural sound picked by the sound pickup module into an electrical audio signal;
an audio signal modulation module, which is integrated to the wireless peripheral device, and which is capable of modulating the electrical audio signal from the sound transducing module into a modulated audio signal;
a transmitting wireless interface module, which is integrated to the wireless peripheral device, and which is capable of converting the modulated audio signal from the audio signal modulation module into a wireless audio signal and emitting the wireless audio signal into the surrounding environment; and
a reception wireless interface module, which is coupled to the computer platform, and which is capable of receiving the wireless audio signal from the transmitting wireless interface module on the wireless peripheral device and transferring the received audio signal to the computer platform.

2. The wireless peripheral voice input device of claim 1, wherein the computer platform is a notebook computer.

3. The wireless peripheral voice input device of claim 1, wherein the computer platform is a desktop computer.

4. The wireless peripheral voice input device of claim 1, wherein the computer platform is a tablet computer.

5. The wireless peripheral voice input device of claim 1, wherein the wireless peripheral device is a wireless multimedia controller.

6. The wireless peripheral voice input device of claim 1, wherein the wireless peripheral device is a wireless mouse device.

7. The wireless peripheral voice input device of claim 1, wherein the reception wireless interface module is coupled to the computer platform by way of a USB (Universal Serial Bus) port.
